(19) United States
(12) Patent Application Publication
(10) Pub. No.: US 2009/0240531 A1
(43) Pub. Date: Sep. 24, 2009

(54) Integrated Processing System

(76) Inventor: Robert Charles Hilborn, West Hartford, CT (US)

Correspondence Address: BUCKLEY, MASCHOFF & TALWALKAR LLC, 50 LOCUST AVENUE, NEW CANAAN, CT, 06840, US

(21) Appl. No.: 12/052,366

(22) Filed: Mar. 20, 2008

(51) Int. Cl. G06Q 40/00

(52) U.S. Cl. 705/4

(57) ABSTRACT

According to one embodiment, an integrated processing system and method is configured to route a customer contact to a handler based at least in part on a contact type and on information identifying the customer, dynamically generate handler scripting based at least in part on the information identifying the customer, a policy, and a claim type. The system further is configured to present the handler scripting to a handler, and receive claim data based on the scripting. The system further validates the claim data based on the claim type, and generates, based on the validated claim data, a claim record in a claims system. The system generates at least a first workflow assignment and notifies a responsible party of the at least first workflow assignment.

### BACKGROUND

Many large entities, such as insurance companies, process customer inquiries using a variety of disparate systems and procedures. Data needed to process each inquiry may be stored in multiple data stores. Different business rules and different customer care or user interface scripting may need to be applied to different types of inquiries. Further, different procedures may be needed to follow up with different inquiries. Typically, the customers and their customer care representatives are forced to patiently work through complex and inefficient user interfaces to collect the data needed for a particular inquiry.

An example of one particularly complex type of customer inquiry is an inquiry to initiate an insurance claim. For example, a customer who holds an automobile insurance policy and who has been in an accident and wants to make a claim under the insurance policy must initiate a claim by contacting the insurance company. Often, the customer initiates the claim by phoning the insurance company and speaking with an agent. The agent must then obtain sufficient information to open a new claim or to create a “First Notice of Loss” (or, “FNOL”). Unfortunately, it can be very difficult for a call center agent to collect all of the information needed to create the FNOL. The type of information needed for a FNOL will depend on the nature of the accident, the parties involved, the insured's policy number, whether a police report was filed, etc. Frequently, a call center representative is unable to remember (or know) to collect all of the needed information during the initial conversation, and an agent must follow-up with the customer at a later time. Similar, if not greater, complexities exist in other types of insurance claim transactions.

Further, in order to process a FNOL, a number of data sources, vendors, and employee activities must be managed. Each of these actions can be time consuming, error prone, and difficult to administer in a cost effective basis.

### BRIEF DESCRIPTION OF THE DRAWINGS

FIGS. 1A and 1B are block diagrams of an integrated claim processing system according to some embodiments of the present invention.

FIG. 2 illustrates claim initiation method according to some embodiments of the present invention.

FIG. 3 illustrates an initial contact and status inquiry method in accordance with some embodiments of the invention.

FIG. 4 illustrates a claim initiation method according to some embodiments of the present invention.

FIG. 5 illustrates a claim processing server according to some embodiments of the present invention.

### DETAILED DESCRIPTION

Pursuant to some embodiments, an integrated claim processing system and method is provided in which the integrated claim processing system is configured to route a customer contact to a handler based at least in part on a contact type and on information identifying the customer, dynamically generate handler scripting based at least in part on the information identifying the customer, a policy, and a claim type. The system further is configured to present the handler scripting to a handler, and receive claim data based on the scripting. The system further validates the claim data based on the claim type, and generates, based on the validated claim data, a claim record in a claims system. The system generates at least a first workflow assignment and notifies a responsible party of the at least first workflow assignment. Applicant has discovered that an integrated claim processing system pursuant to some embodiments results in surprising and desirable improvements in claim processing efficiency and accuracy. For example, Applicant believes that systems pursuant to some embodiments will enjoy 10%-30% (or more) increases in throughput to process a new first notice of loss. Such efficiencies result in improved customer satisfaction, and reduced agent or handler costs.

A technical effect of some embodiments of the invention is improved claim processing accuracy. Prior to embodiments of the present invention, new claim processing was inefficient and subject to errors in data entry and data selection. Embodiments, using dynamic scripting, validation and other techniques, substantially reduce the errors and inefficiencies. With this and other advantages and features that will become hereinafter apparent, a more complete understanding of the nature of the invention can be obtained by referring to the following detailed description and to the drawings appended hereto.

Embodiments of the present invention may be used with desirable results in a number of different claim processing environments. For example, embodiments may be used to process and create new insurance claims, such as claims under auto, life, property, or workers compensation policies. For simplicity, and ease of exposition, embodiments will be described using an illustrative (but not limiting) example relating to the creation of a new claim under an automobile policy. Those skilled in the art will recognize that features described in the illustrative example may be used to desirable advantage in other claim processing situations.

In the illustrative example, an integrated claim processing system pursuant to the present invention is utilized by an insurance company that issues automobile insurance policies. A policy has been issued to a customer named Jane Doe. The policy has a number of terms and conditions, and specifies coverage details and identifies the insured property. In order for Jane Doe to make a claim, she must contact her insurance company, and provide sufficient information for the insurance company to create a “First Notice of Loss” (or, “FNOL”). The FNOL is used by the insurance company to respond to, and process the claim. This illustrative example will be followed throughout the disclosure to illustrate features of some embodiments.

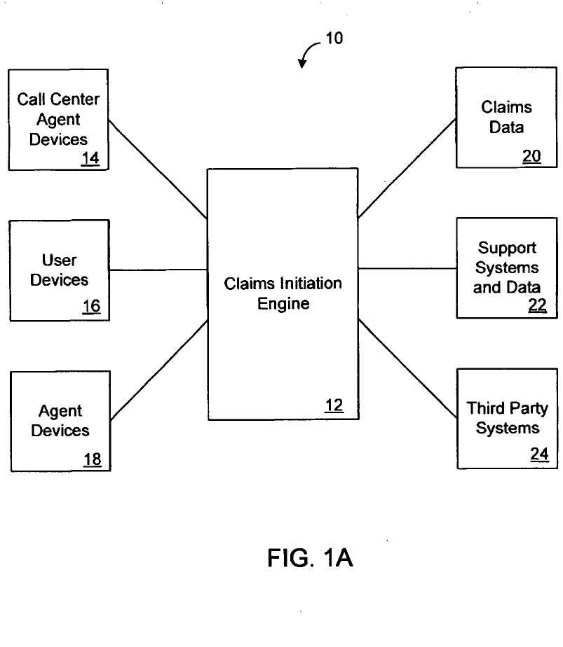

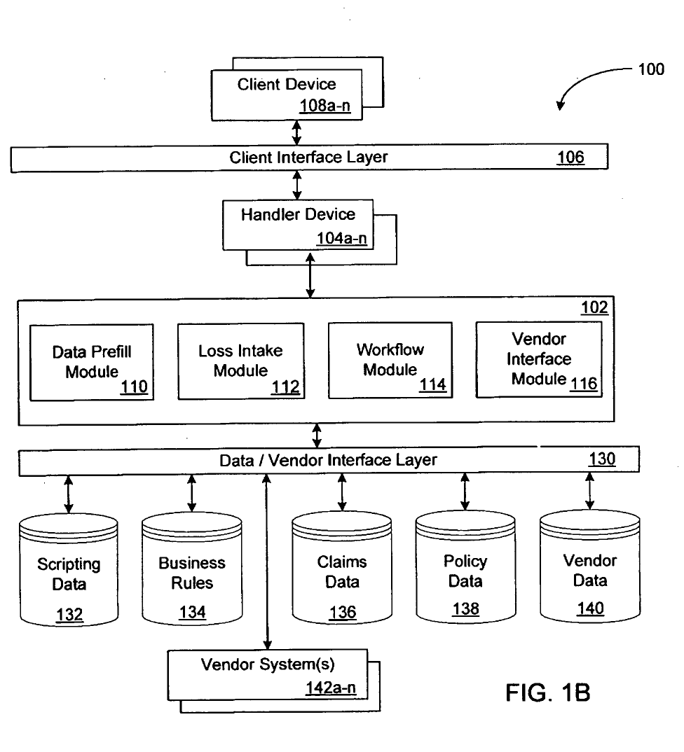

Reference is now made to FIG. 1A, where an integrated claim processing system 10 pursuant to some embodiments is shown. As depicted, integrated claim processing system 10 includes a claims initiation engine 12 in communication with a number of data input and entry devices 14-18 and is also in communication with a number of systems or data sources 20-24. Pursuant to some embodiments, integrated claim processing system 10 is comprised of one or more computing systems, such as servers, interacting to process, route, analyze and manipulate data and information received from a wide variety of different data input and entry devices 14-18 and store, forward, route or otherwise manipulate the data by communication and interaction with a number of different systems or data sources 20-24. For example, as will be described further below, claims initiation engine 12 may receive data from data input and entry devices including call center agent devices 14, user (or claimant) devices 16, or agent devices 18.

While several illustrative input devices are shown in FIG. 1, they are shown only for purposes of discussion. Applicants have discovered that a claims initiation engine 12 pursuant to the present invention allows substantially any type of input device to interact with claims initiation engine 12 to initate a claim. For example, embodiments allow a claim to be initiated via a computer (operated by a claimant, an agent, a call center representative, etc.), by a telephone, or by other devices. Embodiments allow any type of claim contact to be processed appropriately by providing a rules based system that is substantially agnostic to the format or medium by which a claim is submitted to the system.

Embodiments provide a rules based system that ensures that data entered at any of a number of different types of devices is entered in a logical, efficient and accurate fashion, thereby reducing errors and ensuring that claims data is entered properly and new claims are processed appropriately. As will be described further below, claims initiation engine 12 dynamically creates data input screens based on the type of claim being entered and based on the identity of the party entering the data. Pursuant to some embodiments, a wide variety of types of input devices may be supported, including, for example, computer systems, telephones, or the like.

As will be described further below, claims initiation engine 12 interfaces or interacts with a wide variety of back end systems, such as, for example, claims systems or data stores 20, support systems or data stores 22, and third party vendor systems 24. As will be described further below, claims initiation engine 12 provides a standardized interface, ensuring that a wide variety of back end systems may interact with and receive data from claims initiation engine 12. For example, in some embodiments, claims initiation engine 12 may interact with third party vendor systems to provide services associated with a claim initiated by a user interacting with claims initiation engine 12. As a specific illustrative example, claims initiation engine 12 may interact with third party car rental systems, allowing a claim associated with an automobile accident to be created, and to cause, substantially in real-time (e.g., during the transaction in which the claim is being created) procurement of a rental car for the claimant.

While several illustrative output devices are shown in FIG. 1, they are shown only for purposes of discussion. Applicants have discovered that a claims initiation engine 12 pursuant to the present invention allows substantially any type of output or back-end device to interface and interact with claims initiation engine 12 to support creation of and processing associated with a claim. For example, embodiments allow claims data to be stored in a number of different types of data stores (such as a claims data base) or transmitted to a number of different types of third party systems (such as a car rental vendor system). Even further, however, embodiments allow claims data to be communicated to and shared with substantially any type of systems or databases by providing a rules based system that uses a set of standardized interfaces and data structures that are substantially agnostic to the format or medium by which claims data is shared with other systems.

As an example, embodiments of the present invention may be used to interface with substantially any type of vendor support system. Embodiments may be used to schedule services (such as car rental services, window repair services, auto body services, appraisal services, legal services, etc.), purchase goods or services (such as hotel or lodging, etc.), update third party systems with status information, retrieve status information from third party system, or the like. Any or all of this data can be used to update data associated with a given claim to ensure the claim record is up to date and complete.

Embodiments achieve this integration, in part, by creation of a standards-based interface. For example, in the case of integration with a third party car rental system, embodiments define (or comply with) messaging formats used by the third party car rental system to transmit data identifying a car rental request (e.g., including a claimants name and other information, the location where the car is to be rented, and other details) to the third party car rental system, and then to receive car rental information as a response from the third party car rental system. Pursuant to some embodiments, the response data received from the third party systems is used to update the claim information created and stored by the claims initiation engine 12. In this manner, embodiments provide automated and integrated communication among a number of parties and entities associated with the creation, processing and servicing of a claim.

Embodiments allow integration with substantially any input devices or output devices or third party systems. Further, new input devices, output devices, third party systems or the like can be added as needed. The result is a claims initiation system that can adapt to changing market needs while ensuring that claim processing is performed efficiently and pursuant to current business rules and procedures. Further benefits and features will become apparent to those skilled in the art upon reading this disclosure.

Reference is now made to FIG. 1B, where an integrated claim processing system 100 pursuant to some embodiments is shown. As shown, integrated claim processing system 100 includes a claim processing server 102 in communication with a number of devices, data sources or entities. For example, as depicted, claim processing server 102 is in communication with one or more handler devices 104a-n, a client interface layer 106, one or more client devices 108a-n, and a number of data stores and third party systems. For example, claim processing server 102 is in communication with a scripting data store 132, a business rule data store 134, a claim data store 136, a policy data store 138, a vendor data store 140, and one or more vendor systems 142.

A customer (or policy holder) may operate a client device 108 to initiate a claim with an insurance company operating claim processing server 102. Pursuant to some embodiments, a number of different types of client devices 108 may be used to initiate a claim. For example, client device 108 may be a telephone, a handheld, portable or desktop computer, a kiosk, a wireless handset, or the like. Each client device 108 may initiate communication with claim processing server 102 via a client interface layer 106. Client interface layer 106 may be or include a number of different types of interfaces, depending on the type of client device 108 used. For example, client interface layer 108 may include a PBX, an interactive voice response (“IVR”) unit or other telephone switching mechanism to receive telephone contact from a customer operating a telephone as a client device. Client interface layer 108 may also include an Internet-based layer allowing a client to initiate contact via a computing device over the Internet or other networks.

Pursuant to some embodiments, client interface layer 106 may include some functionality to prescreen or identify a customer and retrieve basic information about the contact. For example, in an embodiment in which the client device is a telephone, client interface layer 106 may operate to perform a reverse telephone lookup or other identification to identify the customer. In some embodiments, an IVR menu may request identifying information from the customer. In some embodiments, a Web-based interface may request identifying information from the customer. This identifying information may be used to route the customer to an appropriate handler for further processing.

As used herein, devices and interfaces (e.g., such as client device 108, client interface layer 106, handler device 104, claim processing server 102, data/vendor interface layer 130, data stores 132-140 and/or vendor systems 142) may exchange information via a communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that devices may communicate via one or more such communication networks.

A number of handler devices 104 may be provided to interact with and respond to requests from client devices 108. In some embodiments, handler devices 104 may be associated with agents or representatives of the entity operating integrated claim processing system 100. For example, handler devices 104 may include computer workstations operated by customer service agents employed to interact with customers over the telephone. In such embodiments, a customer service agent may be associated with a handler device 104 such as a personal computer or computer workstation, where the computer is in communication with claim processing server 102. In other embodiments, handler devices 104 may be computing devices configured with software to communicate with client devices 108 to obtain information directly from the customer without operator or agent involvement. For example, in such an embodiment, handler devices 104 may be server devices configured to receive claim information entered by customers into client devices 108.

Claim processing server 102 includes a number of different modules, each of which may configured to perform processing to support operation of the claim processing server as described herein. For example, as depicted, claim processing server 102 includes a data prefill module 110, a loss intake module 112, a workflow module 114 and a vendor interface module 116. Each or all of the modules operate on data obtained from client devices 108, agent devices 104 and one or more data sources including data stores 132-140 (as well as, in some embodiments, data from one or more vendor systems 142). For example, data prefill module 110 operates to retrieve data from policy data store 138 and claims data store 136 to prefill or prepopulate data screens of handler devices 104 and/or client devices 108 (e.g., to reduce the amount of data entry and avoid errors in data entry when a new claim or other inquiry is being processed). As another example, loss intake module 112 operates to dynamically create a series of screens or scripts for agents operating handler devices 104 in response to a new claim request by a customer. Loss intake module 112 dynamically creates the series of screens or scripts based on data from a customer, policy data from policy data store 138, business rules from business data store 134 and scripting data from scripting data store 132. In some embodiments, each question presented to a customer in processing a FNOL or other claim is generated dynamically based on data from each of these data stores, thereby ensuring that the correct questions and data are obtained for each claim.

Workflow module 114 operates to create and assign tasks and activities to employees or agents based on the characteristics of a given FNOL or other claim. In one embodiment, workflow module 114 is based on the PEGA system from PEGASystems®. Workflow module 114 may, for example, generate a series of tasks and activities required to fully process a new claim so that the claim is processed accurately and promptly. The module operates based on data retrieved from claims data store 136 and business rules data store 134 to ensure that each claim is processed pursuant to current business rules and procedures. Pursuant to some embodiments, workflow module 114 may access one or more separate data stores (not shown) to store workflow and workflow rules data.

Vendor interface module 116 operates to control communications between third party vendor systems (such as vendor systems 142) and claim data associated with claims processed using claim processing server 102. For example, vendor interface module 116 may facilitate communication during the creation of a FNOL to secure vendor services for a customer who has initiated a claim. As a specific illustrative example, for a customer who has initiated a FNOL for an automobile policy claim, vendor interface module 116 may operate to allow a customer service agent operating handler device 104 to secure a car rental reservation with a partner vendor so that the customer is able to quickly obtain a temporary replacement vehicle. As another illustrative example, vendor interface module 116 may initiate a request, and secure an appointment, for an appraiser to inspect and appraise the damage to the customer's vehicle. In this manner, by allowing direct interaction with third party vendor systems 142, claim processing server 102 may efficiently control all aspects of a claim process, ensuring that customers enjoy a greater quality of service, reduced delays, and improved communication. Further, pursuant to some embodiments, the data returned from third party vendor systems 142 is used to update the claims data stored in claims data store 136, thereby ensuring the claims data reflects a full record of actions, services, and information associated with each claim.

Those skilled in the art will appreciate that some or all of the modules 110-116 may be implemented using shared code or using different servers. Some of the modules, such as workflow module 114, may be based on or comprise third party software, either customized or off the shelf. In some embodiments, for example, claim processing server 102 may be comprised of an application server in communication with one or more database servers (where the database server stores or otherwise accesses data from data stores 132-140). In some embodiments, claim processing server 102 may be set up with a mirrored or secondary server to ensure high reliability.

Although a single claim processing server 102 is shown in FIG. 1B, any number of claim processing servers 102 may be included in the system 100. Similarly, any number of devices 104, 106, 108 (and any other devices described herein) may be included according to embodiments of the present invention. Note that the claim processing server 102 might comprise one or more servers adapted to receive, store, process and/or transmit claim information associated with clients and/or data.

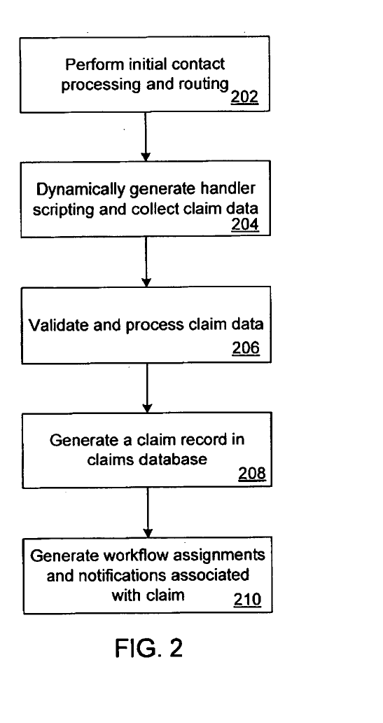

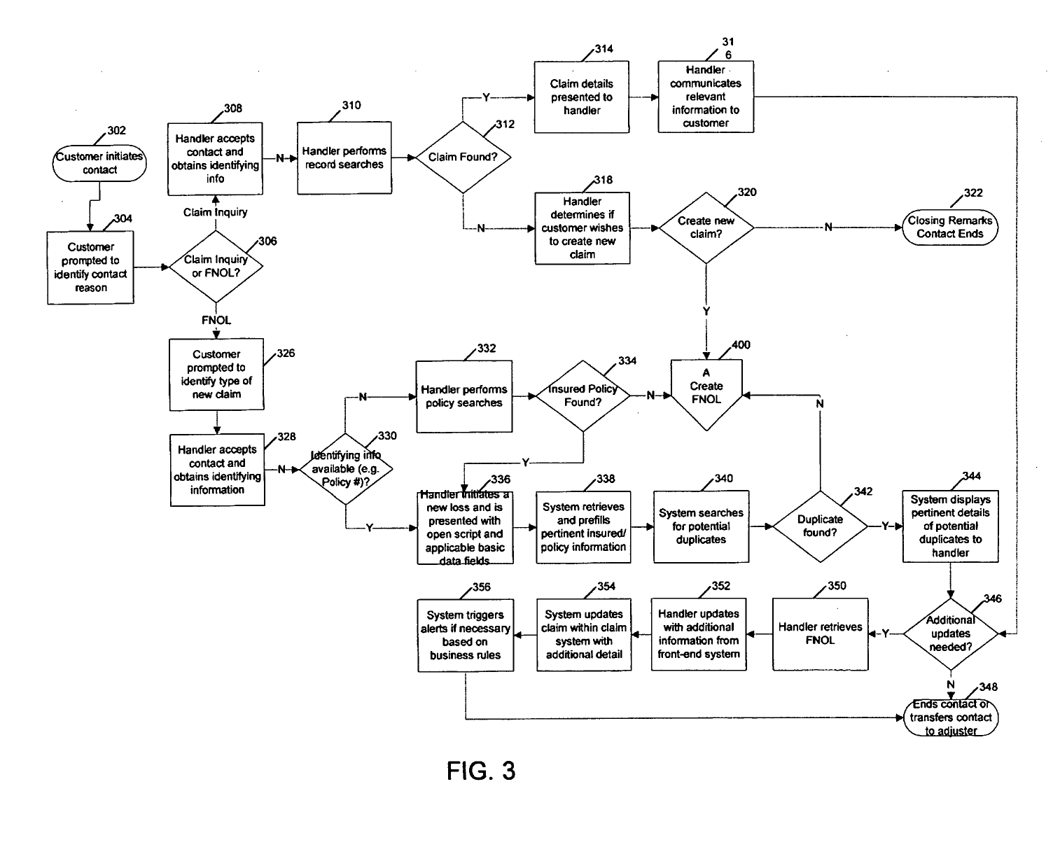

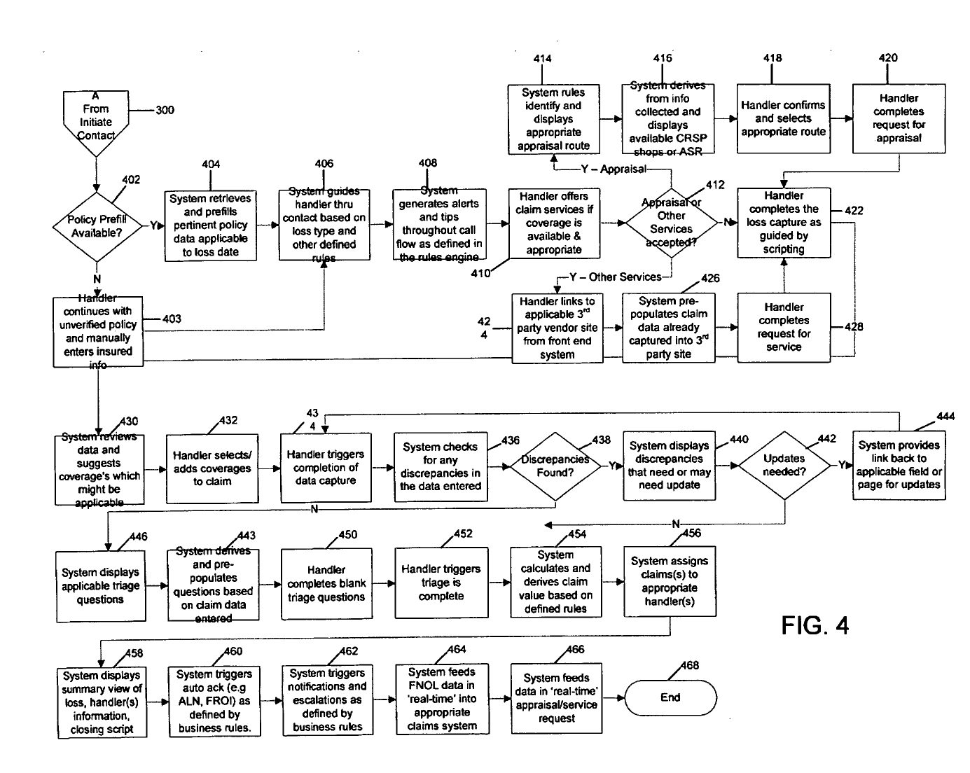

Claim processing server 102 may be associated with, for example, an insurance company processing claims solely for that company, or with an independent entity (e.g., independent of the insurance company) that operates a claim processing service on behalf of the insurance company. Moreover, the claim processing server 102 may operate in accordance with any of the embodiments described herein. For example, FIG. 2 illustrates a claim initiation method 200 according to some embodiments. The flow charts described herein do not imply a fixed order to the steps, and embodiments of the present invention may be practiced in any order that is practicable. Further details of some embodiments of claim initiation method 200 will be provided in conjunction with FIGS. 3 and 4 below, FIG. 2 provides an overview of some embodiments.

Claim initiation method 200 begins at 202, where integrated claim processing system 100 (of FIG. 1B) receives a customer contact and performs initial contact processing and routing. For example, referring to the elements of FIG. 1B, customer contact may be received in a number of ways, including via telephone contact where the customer operates a telephone to contact a client interface layer 106 (such as a PBX or IVR unit or direct to an agent operating a handler device 104). Processing at 202 may include prescreening the contact and identifying the type of contact. For example, in some embodiments, processing at 202 includes identifying the customer (e.g., by direct questioning by a live agent, by a phone directory lookup in an IVR, or the like) and identifying the type of contact or inquiry being made (e.g., again by direct questioning by a live agent, by a voice menu in an IVR or PBX system, or the like). In general, processing at 202 includes processing to identify who is calling (or otherwise making contact), and what the purpose of the call or contact is. Continuing the illustrative example introduced above involving Jane Doe and her automobile insurance policy, processing at 202 includes identifying the caller as “Jane Doe” and identifying that her call is regarding a new claim under her automobile insurance policy.

The information obtained at 202 is used to route the contact based on the identified contact type and customer information. For example, in some embodiments, a determination is made whether the customer is making a claim inquiry (e.g., to check on the status of a previously initiated-FNOL) or to create a new FNOL. As will be discussed further below in conjunction with FIG. 4, the process for handling a contact involving a new FNOL may be different than the process for handling an inquiry regarding an existing FNOL. Continuing the example involving Jane Doe, processing at 202 includes routing Jane Doe to a handler capable of initiating a FNOL for automobile insurance claims.

For the purposes of FIG. 2, however, processing at 202 includes identifying who the customer is, and what the purpose of the contact is, and then routing the contact to an appropriate handler for processing. Once routed, processing continues at 204 where integrated claim processing system 100 operates to dynamically generate handler scripting and collect claim data.

For example, processing at 204 includes interaction with loss intake module 112 of claim processing server 102. Loss intake module 112, using data obtained from the initial contact with the customer, causes a series of dynamic scripts or interfaces to be built during the contact. These scripts or interfaces are built or selected based on the type of contact and the nature of the inquiry using data from scripting data store 132, business rules data store 134 as well as data associated with the customer's policy (retrieved from policy data store 138). For example, in the illustrative example introduced above, where Jane Doe is calling to initiate a claim under her automobile insurance policy, processing at 204 includes activating loss intake module 112 to retrieve relevant data from Jane Doe's insurance policy (from policy data store 138), and constructing one or more data input screens to process a FNOL for an automobile insurance claim under Jane's type of policy.

Those skilled in the art, upon reading this disclosure, will appreciate that different claims and different policies will have a wide variety of types of data to be collected. Embodiments of the present invention allow the dynamic and efficient creation of scripts and interfaces that are relevant to different claims and different policies so that handlers (such as call center representatives) ask and receive data that is relevant to a particular claim. This ensures that processing time is reduced and errors minimized. Details of examples of different types of scripting and data will be provided below in conjunction with FIGS. 3 and 4.

Once the claim data has been collected, processing continues at 206, where claim processing server 102 operates to validate and process the claim data. Pursuant to some embodiments, to reduce errors, and to ensure that a claim record is complete, a validation process is performed when the handler (such as a customer service agent) indicates that the data collection process is complete (e.g., once all of the data associated with the intake scripts have been received). The validation process performed may vary based on the type of claim being processed pursuant to different business rules. For example, the validation processing for an automobile claim will be different than the validation processing for a workers compensation claim. Pursuant to some embodiments, the validation processing performed at 206 may include identifying discrepancies in data entered, missing data elements, and other data problems that could disrupt processing of the claim. Processing at 206 includes presenting the handler with a list of discrepancies that need to be addressed before the claim can be processed. In some embodiments, processing at 206 is performed while the handler is in communication with the customer (e.g., while the customer service representative is on the phone with a customer, or while the customer is on a Website entering their claim information). In some embodiments, processing at 206 includes the generation of one or more triage questions that are selected to resolve the discrepancies. These triage questions are dynamically generated based on the claim data entered at 204. Processing at 206 may be iterative. That is, discrepancies and triage questions are generated and resolved until the claim is ready for submission.

In some embodiments, processing at 206 is performed substantially on a continuous basis as each item of data is obtained. That is, triage processing is performed at multiple times during execution of process 200 to ensure that all of the data collected during process 200 is consistent, accurate and relevant. For example, processing at 206 may be performed when certain key or relevant items of data are input during processing to ensure that the overall claim is processed appropriately. As a simple illustrative example, when Jane Doe calls a call center representative to initate a FNOL for her auto accident, processing at 206 may be automatically performed as the represenative enters certain information about the accident to make sure that only relevant questions about the accident are asked, and that all needed data about the accident is captured to complete the FNOL.

Once all of the claim discrepancies are resolved, processing continues at 208, and claim processing server 102 allows a claim record to be generated and stored in claims data store 136. In some embodiments, once a claim record is generated, a unique claim identifier is generated and communicated to the customer for future reference.

Processing continues at 210 where one or more workflow assignments and notifications associated with the new claim are generated. In some embodiments, each of the workflow tasks needed to fully process a claim is generated. The number of tasks, assignments and notifications will depend on the nature and type of claim. For example, in the illustrative example involving Jane Doe's automobile insurance claim, workflow assignments may include the assignment of an appraiser (which may be a third party vendor) and assignment of a case manager. Processing at 210 includes the generation of specific tasks to the parties, as well as generating appropriate notifications to the parties. For example, the assigned appraiser may receive a notification message providing details of the claim, details of the vehicle to be appraised, as well as a schedule in which to complete the appraisal. The case manager may receive a notification alerting them of the new claim as well as a set of tasks to complete to process the claim. Further details of different types of workflow assignments and notifications will be provided below in conjunction with FIG. 4. The result is a system that allows a wide variety of claims to be efficiently processed.

Reference is now made to FIG. 3, where an initial contact and status inquiry process 300 is shown. Process 300 may be performed using the integrated claim processing system 100 of FIG. 1B. Process 300 begins at 302 when a customer initiates contact with integrated claim processing system 100 (e.g., via telephone, computer, or the like). Processing continues at 304 where the customer is prompted to identify the contact reason. For example, in a situation in which the customer contacted the system by telephone, processing at 304 may include a menu of automated prompts asking the customer to enter a policy number and identify one of a “type” of caller they are such as, for example: an insured, an insured's attorney, a insured agent, an other type of caller, a third party, a third party attorney, a third party agent, or other type of third party. If the caller is a type of caller that can initiate a claim or inquire about an existing claim (e.g., the caller is either the insured, the insured attorney, or the insured's agent), the system may continue to further identify the customer and their policy information. For example, the system may ask the customer to verify their contact information (which is retrieved, substantially in real time, from policy data store 138 based on the entered policy number). In some embodiments, during processing at 304, any missing information from the policy data store 138 (such as alternative contact information) may be retrieved and used to update policy data store 138.

Processing continues at 306 where the contact reason is determined and the contact is routed based on whether the contact is a claim inquiry or a new claim (e.g., such as a FNOL). If the customer indicates that it is a simple claim inquiry, processing continues at 308 where a handler accepts the contact and obtains further identifying information. For example, the handler (such as a customer service representative or an automated agent) may prompt the customer to enter information identifying the claim. Record searches are performed at 310 in an attempt to identify a claim that exists and matches the information provided at 308. For example, a variety of queries may be performed against data in claims data store 136 and policy data store 138. If a determination is made at 312 that the desired claim was found, processing continues at 314 where the claim details are presented or displayed to the handler and the handler then, at 316, communicates the relevant information to the customer. For example, a customer may be interested in the current status of an existing claim. This information is communicated to the customer at 316. Processing continues at 346 where a determination is made whether any additional updates to the claim are needed.

If updates are required, processing continues at 350 where the handler retrieves the FNOL or claim record (e.g., from claims data store 136) and, interacting with the customer, causes the record to be updated with any update information obtained during the contact at 352. The additional information is posted to the FNOL or claim record at 354. Pursuant to some embodiments, loss intake module 112 (or a similar module) is operated to validate and process the updated information to ensure that no apparent errors or inconsistencies are present in the update. In some embodiments, if any errors or inconsistencies are present, the system 100 generates alerts notifying the handler of the errors. Pursuant to some embodiments, these alerts are based on business rules retrieved from business rule data store 134. For example, business rule data store 134 includes data specifying data requirements for specific types of claims. Any deviation from the data requirements may trigger an error message or alert. In this manner, embodiments ensure that updates to claim data are performed in accordance with business rules relevant to the claim type.

Once any alerts or errors are remedied, processing continues at 348 where the contact with the customer is concluded or, if needed, the customer is transferred to an adjuster or other agent to address other issues.

Referring again to 312, if the determination at 312 is that a claim cannot be found based on the searches performed at 310, the handler determines whether the customer wishes to create a new claim. If the customer does not wish to make a new claim, processing concludes at 322. If the customer does wish to make a new claim, processing continues to 400 (shown in FIG. 4).

Referring again to the determination at 306 of whether the customer is making contact to inquire about a current claim or a new claim, if the customer is making contact to initiate a new claim, processing continues at 326 where the customer is prompted to identify the type of claim. For example, in the illustrative embodiment where Jane Doe would like to initiate a claim under her automobile insurance policy, she may indicate that she wishes to initiate such a claim at 326.

Processing continues at 328 where a handler (e.g., such as a customer service agent operating a handler device such as device 104 of FIG. 1B, or a computer server interacting with a customer over the Internet, etc.) accepts the contact and obtains further identifying information. For example, at 328, the handler may verify the policy number under which the claim is being made.

Processing continues at 330 where a determination is made whether the policy number was available or provided at 328. In some situations, for example, the customer may not have their policy number available, in which situation processing proceeds at 332 where the handler performs policy searches of policy data store 138 to attempt to locate the relevant policy. If the policy is found, processing continues at 336. If the policy is not located, processing continues at 400 and a FNOL is created.

If the policy number is found at 330, processing continues at 336 and the handler initiates a new loss claim under control of loss intake module 112 of claim processing server 102 (FIG. 1B). Pursuant to some embodiments, processing at 336 is based on business rules from business data store 134 and scripting data from scripting data store 132, thereby allowing dynamic selection and presentation of scripts to the handler during the contact. For example, the series of scripts presented may depend on the type of claim and the nature of the policy. A claim of collision loss under an automobile policy will involve a different series of scripts than a claim of non-collision window damage under the same automobile policy. In this manner, claims are processed efficiently and without the collection of unneeded data. Further details of the creation of a claim will be provided below in conjunction FIG. 4.

With each script or screen presented to the handler, processing at 338 is performed to prefill any data fields with existing data from policy data store 138, thereby reducing the amount of data entry required and minimizing data entry errors.

At 340, claim processing server 102 performs a search for potential duplicate claims to ensure that a claim has not been entered twice. If a duplicate is found, claim processing server 102 causes the relevant details of the potential duplicate claim to be displayed to the handler at 344. At this point, the handler can determine whether any additional updates to the existing claim are required at 346. If so, the handler retrieves the existing FNOL (or claim documentation) at 350 and updates the record with the updated data received from the customer at 352. When the updates have been made, the data is updated and analyzed to determine whether the updates trigger any alerts or notifications based on existing business rules. The handler remedies any alerts and the updated record is stored in claim data store 136, and the contact concludes.

In situations where a new FNOL (or other type of claim) needs to be created, processing continues to the claim creation process 400 of FIG. 4.

Claim creation process 400 begins at 402. At this point, a contact has been assigned to a handler, and basic data about the customer and the claim are known. Further, it has been determined that no duplicate claims exist. Processing at 402 includes determining if a policy prefill is available. That is, data prefill module 110 of claim processing server 102 attempts to retrieve existing policy data from policy data store 138 to prefill data for the handler. If policy data is available, claim processing server 102 retrieves the data and prefills relevant policy data applicable to the new claim at 404. If policy data is not available, the handler continues processing using unverified policy data and manually enters the customer's information at 403. Processing continues at 406 where claim processing server 102 guides the handler through the contact by presenting a dynamically generated sequence of scripts and data screens, where the sequence is created based on the policy data, business rules, and the loss information. For example, continuing the example involving Jane Doe introduced above, processing at 406 may include presenting the handler with a series of screens to allow the handler to capture information associated with: the loss, the vehicle(s) involved in the incident, the party(s) involved, any pedestrian information, etc.

For example, Jane Doe may be taken through a series of questions regarding the loss. Each subsequent question may depend on the response to a prior question, policy information, or business rules. For example, system 100 may prompt the handler to ask the customer to provide further details, such as whether the “insured vehicle” was at fault or whether another (or “other vehicle”) was at fault. Further information such as the location of the accident, the date of the accident, a statement from the customer regarding the loss, a description of the claim, the number of vehicles involved, the insured vehicle information, information identifying any third party vehicles involved, details of the accident (speed, etc.), a description of any other property damage, etc. Based on the answers to each of these questions, further scripting and screens may be generated to collect additional information such as: further vehicle details, information identifying the parties involved, including any pedestrian or witness information.

As each screen or script is processed by the handler, claim processing server 102 validates the data substantially in real time to offer tips and alerts. For example, if a field is required but is not filled in, an alert will remind the handler to collect the data for the field. As another example, if a date is entered but is inconsistent with the claim, an alert will remind the handler to verify the date. These alerts and tips are generated based on business rules from business rules data store 134. Once the scripts and screens have been completed and the loss information has been collected, processing continues at 410 where the handler is prompted to offer one or more claim services if coverage is available and appropriate. The availability and appropriateness of any claim services is determined by claim processing server 102 by consulting policy data in policy data store 138, business rules from business rules data store 134 and the claim data entered to this point. As an example, vehicle appraisal services may not be available if the insured vehicle is in a State that requires the acceptance of a mechanic's estimate rather than an appraisal. A wide variety of business rules may be consulted to determine the availability and/or appropriateness of a given claim service.

For example, in the illustrative example involving Jane Doe and her automobile claim, available claim services may include vehicle servicing, vehicle appraisal, rental of a rental car, etc. In Jane Doe's example, if her insured vehicle was undriveable, she may be offered one or more of the services. Pursuant to some embodiments, the details of each offered claim service are presented to the handler for communication to the customer. Processing continues at 412 where a determination is made whether the customer accepts one or more of the claim services. If the system determines that vehicle appraisal services are available, and the customer accepts the appraisal services, processing continues at 414 where claim processing server 102, using business rules, policy information, and claim information, determines the most appropriate appraisal option to take.

The determination of the most appropriate appraisal option can depend on a variety of factors, including the State in which the vehicle is located (as different States have different laws regarding appraisals), whether the vehicle can be inspected, whether the vehicle can be moved, etc. Claim processing server 102 determines which path is most appropriate for the instant claim, and at 416 retrieves information from third party vendor systems to identify the nearest appraisal facilities to the customer's location. Processing continues at 418 where the handler confirms the information and selects the most appropriate appraisal option and communicates the information to the customer. Processing continues at 420 where the handler completes the appraisal request.

If processing at 412 indicates that other claim services are required or desired, processing continues at 424 where claim processing server 102 communicates with third party vendor systems 142, such as auto rental vendor systems, glass repair vendor systems, etc. In some embodiments, communication between claim processing server 102 and vendor systems 142 may be performed using XML, HTTP, HTTPS or other standard formats so that claim processing server 102 can post data to the vendor systems and receive response data in return. The response data is, in some embodiments, captured and stored in the claim data record associated with the claim. Pursuant to some embodiments, a handler may interact with vendor systems using server 102 and schedule repair services, secure a rental car reservation, or the like, all while in contact with the customer. Processing continues at 422 where the handler completes the loss capture. That is, at 422 the handler has collected all of the loss data required by the scripting and screens dynamically presented by claim processing server 102.

Processing continues at 430 where claim processing server 102 reviews the loss data submitted by the handler, and suggests one or more coverage(s) that may be applicable to remedy the loss. Processing at 430 is based on the loss data entered by the handler, business rules stored in business rule data store 134, and policy data from policy data store 138, for example. Claim processing server 102 causes the coverage(s) details to be presented to the handler for communication to the customer. The handler, at 432, selects and/or adds the coverage(s) to the claim record.

At 434, the handler triggers completion of the claim data capture by “submitting” or otherwise committing the data. At 436, claim processing server 102 analyzes the claim data for any discrepancies by consulting, for example, business rules from business data store 134 that are relevant to the claim data. If any discrepancies are found, processing continues at 440 where the discrepancies or items that require further attention are flagged and displayed to the handler. For example, data items that require further attention may be highlighted or listed along with reasons why the discrepancies were flagged. In some embodiments, tips or instructions to the handler may also be displayed. The handler then reviews the flagged items and determines whether any updates are needed (at 442). If any updates are needed, processing continues at 444 where claim processing server 102 provides a link back to the appropriate fields and/or a link to the appropriate script or screen so that the handler can remedy and update the issue. Processing at 434-442 repeats until all discrepancies are remedied, and no further updates to data are required.

Processing continues at 446 where claim processing server 102 further analyzes the claim data to generate one or more “triage” questions. As discussed above, in some embodiments, the generation of “triage” questions does not necessarily happen at a single point in time, but rather occurs throughout process 400 as data is entered to ensure that the data is entered correctly, and that the appropriate data for a given claim has been collected. Pursuant to some embodiments, claim processing server 102 prefills certain claim data elements captured during the claim processing into any applicable questions that relate to the downstream assignment or assessment of the claim. That is, some embodiments create an automated initial assessment of how to resolve a claim by performing a triage. Pursuant to some embodiments, claim processing server 102 integrates substantially in real-time with the workflow module 114 so that data can flow between handlers and the workflow module to assign and distribute tasks in an automated fashion. The result of the triage assessment can be automated assignment of tasks based on claim handler characteristics, skill set, scheduling, and workload capacity to determine loss assignment location.

Pursuant to some embodiments, a number of different triage questions are prepopulated with data based on the data entered during the claim data entry process. Other questions may require answering by the handler at 450. Once all of the triage questions are answered, processing continues at 452 where the handler indicates that the triage has been completed. At 454 claim processing server 102 calculates and derives a value for the claim based on business rules associated with business rule data store 134. The claim value is appended to the claim record, and the claim record is updated in claims data store 136. Processing continues at 456 where claim processing server 102, operating workflow module 114, performs workflow and task assignments based on the triage assessment, and based on other characteristics of the claim data. In some embodiments, processing at 456 includes assigning tasks and activities to one or more claim handlers for resolution. In some embodiments, an assigned claim handler will receive a copy of the claim file and completed FNOL by electronic mail or other messaging, along with a scheduled completion date for certain activities. In some embodiments, one or more managers responsible for the assigned claim handler will also receive electronic communications notifying them of the assignment and the assigned tasks and activities.

Processing continues at 458 where the handler interacting with the customer is presented with a summary screen displaying details of the claim, the loss, the assigned claim handler(s), details of scheduled items, and a closing script. In some embodiments, processing at 458 completes the interaction between the customer and the handler (although the customer may make further contact and obtain claim information using the process of FIG. 3).

Processing continues at 460 where claim processing server 102 triggers one or more automated notifications depending on the nature of the claim. For example, completion of a claim for a workers compensation claim may trigger the generation of a “First Report of Injury” or FROI. Other notifications required by law or business rules may also be generated at 460.

Processing continues at 464 where claim processing server 102 feeds the FNOL data substantially in real time into other related systems as needed. For example, in systems in which a separate platform is used to process claims after FNOL or FROI, a data feed may be initiated to transmit the claim record to that system. Further, processing at 466 may trigger a feed (in some embodiments, substantially in real time) to third party service providers such as vendors operating vendor systems 142. In this manner, new claims are processed from initial contact, to completion of FNOL or FROI in minutes with a high degree of confidence that substantially all needed data has been captured, and that any interested parties (including third party vendors and systems) are updated with details of the loss and claim.

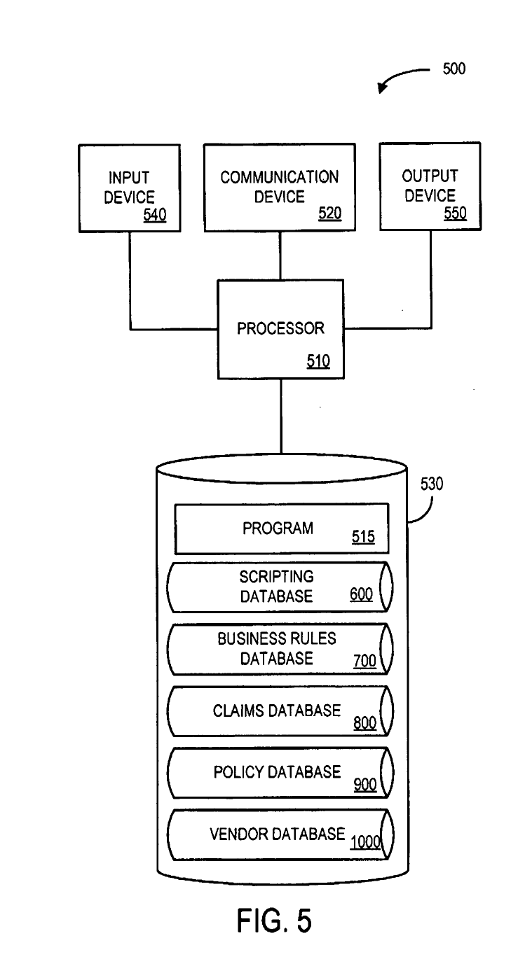

FIG. 5 illustrates a claim processing server 500 that might be descriptive, for example, of the server 102 illustrated in FIG. 1 in accordance with an exemplary embodiment of the invention. The claim processing server 500 comprises a processor 510, such as one or more INTEL® Pentium® processors, coupled to a communication device 520 configured to communicate via a communication network (not shown in FIG. 5). The communication device 520 may be used to communicate, for example, with one or more handler devices 104, customer devices 108 and/or vendor systems 142.

The processor 510 is also in communication with one or more input devices 540. Input device 540 may comprise, for example, a keyboard, a mouse or other pointing device, and/or a microphone. Such an input device 540 may be used, for example, to enter business rules, scripting data, or other information. Processor 510 is also in communication with one or more output devices 550. Output device 550 may comprise, for example, a display screen or printer. Such an output device 550 may be used, for example, to provide reports, view claim information, update scripting, etc.

Processor 510 is also in communication with one or more storage devices 530. Storage device 530 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

Storage device 530 stores one or more programs 515 for controlling the processor 510. Processor 510 performs instructions of the program 515, and thereby operates in accordance with the present invention. For example, the processor 510 may receive claim information from handler device 104 and perform loss intake processing, workflow assignment or other processes as described herein (e.g., including the processing described above in conjunction with FIGS. 2-4).

As used herein, information may be “received” by or “transmitted” to, for example: (i) the claim processing server 500 from one or more handler devices 104, client devices 108 and/or vendor systems 143; or (ii) a software application or module within the claim processing server 500 from another software application, module, or any other source.

As shown in FIG. 5, the storage device 530 also stores: a scripting database 600, a business rules database 700, a claims database 800, a policy database 900, a vendor database 1000, and other databases or data sources required to support the processing of FIGS. 1-4.

In this manner, a system may be provide that allows new claims to be created, managed, and processed with an increased level of automation, accuracy and efficiency. Note that the automation may lower transaction costs and these savings might be shared by all parties (e.g., the insured and the insurer).

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, not that any number of other configurations may be provided in accordance with embodiments of the present invention (e.g., some of the information associated with the databases 600-1000 may be combined or stored in external systems). Moreover, although examples of specific types of claims involving automobile losses have been used, embodiments of the present invention could be used with other types of claims. Further, while embodiments were described in which customers interact with handlers (such as customer service representatives), other embodiments may involve customers interacting directly with claim processing server 102 via a computer interface in which the screens and loss data are presented directly to the customer.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. An integrated processing system, comprising:
a communication device to receive and transmit information;
a processor coupled to the communication device; and
a storage device in communication with said processor and storing instructions adapted to be executed by said processor to:
route a customer contact to a handler based at least in part on a contact type and on information identifying said customer;
dynamically generate handler scripting based at least in part on said information identifying said customer, a policy, and a claim type;
present said handler scripting to a handler, and receive claim data based on said scripting;
validate said claim data based on said claim type;
generate, based on said validated claim data, a claim record in a claims system; and
generate at least a first workflow assignment and notify a responsible party of said at least first workflow assignment.

2. The system of claim 1, said storage device further storing instructions adapted to be executed by said processor to:
determine a status of a claim associated with said customer.

3. The system of claim 1, wherein said communication device is in communication with an interactive voice response unit receiving said customer contact and said customer contact is routed under control of said interactive voice response unit.

4. The system of claim 1, wherein said communication device is in communication with a network and said customer contact is received over said network connection and said customer contact is routed using said network connection.

5. The system of claim 1, wherein said handler is a representative operating a handler device.

6. The system of claim 1, wherein said handler is a computing device in communication with said customer over a network connection.

7. The system of claim 1, wherein said contact type is an inquiry contact, said storage device further storing instructions adapted to be executed by said processor to:
receive information identifying an alleged claim;
determine that said alleged claim does not exist; and
treat said contact type as a new claim contact type.

8. The system of claim 1, wherein said processing to validate includes:
processing to identify at least a first business rule associated with said claim type; and
processing to compare said claim data to said at least first business rule to identify an error.

9. The system of claim 8, said storage device further storing instructions adapted to be executed by said processor to:
require resolution of said error prior to the generation of said claim record.

10. The system of claim 1, said storage device further storing instructions adapted to be executed by said processor to:
compare at least a second business rule associated with said claim type to said claim data to generate a set of triage questions.

11. The system of claim 10, said storage device further storing instructions adapted to be executed by said processor to:
enforce completion of said set of triage questions prior to the generation of said claim record.

12. The system of claim 11, wherein the generation of said at least a first workflow assignment is based at least in part on said completion of said set of triage questions.

13. The system of claim 1, said storage device further storing instructions adapted to be executed by said processor to:
determine, based on at least a first business rule, that at least a first claim service option is available to said claim.

14. The system of claim 13, said storage device further storing instructions adapted to be executed by said processor to:
access a vendor data source associated with said at least first claim service option;
transmit confirmation data to said vendor causing said at least first claim service option to be performed by said vendor; and
update said claim data based on information from said vendor data source.

15. The claim system of claim 13, said storage device further storing instructions adapted to be executed by said processor to:
access a plurality of vendor data sources associated with said at least first claim service option;
identify a most desirable vendor;
transmit confirmation data to said most desirable vendor, causing said at least first claim service option to be performed by said most desirable vendor; and
update said claim data based on information from said most desirable vendor.

16. The method of claim 15, wherein said instruction adapted to be executed by said processor to identify a most desirable vendor includes at least one of: identifying a lowest price, identifying a nearest location, and identifying a preferred provider.

17. The integrated processing system of claim 1, further comprising:
a database to store at least one of: (i) a scripting database, (ii) a business rule database, (iii) a claims database, (iv) a policy database, or (v) a vendor database.

18. A method of processing a claim, comprising:
routing a customer contact to a handler based at least in part on a contact type and on information identifying said customer;
dynamically generating handler scripting based at least in part on said information identifying said customer, a policy, and a claim type;
presenting said handler scripting to a handler, and receiving claim data based on said scripting;
validating said claim data based on said claim type;
generating, based on said validated claim data, a claim record in a claims system; and
generating at least a first workflow assignment and notifying a responsible party of said at least first workflow assignment.

19. The method of claim 18, further comprising:
identifying at least a first business rule associated with said claim type; and
comparing said claim data to said at least first business rule to identify an error.

20. The method of claim 19, further comprising:
requiring resolution of said error prior to said generating said claim record.

21. The method of claim 18, further comprising:
comparing at least a second business rule associated with said claim type to said claim data to generate a set of triage questions.

22. The method of claim 21, further comprising:
requiring completion of said set of triage questions prior to said generating said claim record.

23. The method of claim 22, wherein said generating at least a first workflow assignment is based at least in part on said completion of said set of triage questions.

24. A computer-readable medium storing instructions adapted to be executed by a processor to perform a method of processing a claim, said method comprising:
routing a customer contact to a handler based at least in part on a contact type and on information identifying said customer;
dynamically generating handler scripting based at least in part on said information identifying said customer, a policy, and a claim type;
presenting said handler scripting to a handler, and receiving claim data based on said scripting;
validating said claim data based on said claim type;
generating, based on said validated claim data, a claim record in a claims system; and
generating at least a first workflow assignment and notifying a responsible party of said at least first workflow assignment.

25. The computer-readable medium storing instructions adapted to be executed by a processor to perform a method of processing a claim of claim 24, the method further comprising:
determining a status of a claim associated with said customer.

26. The computer-readable medium storing instructions adapted to be executed by a processor to perform a method of processing a claim of claim 25, wherein said contact type is an inquiry contact, the method further comprising:
receiving information identifying an alleged claim;
determining that said alleged claim does not exist; and
treating said contact type as a new claim contact type.
